(19) United States
(12) Patent Application Publication
(10) Pub. No.: US 2020/0290111 A1
(43) Pub. Date: Sep. 17, 2020

(54) METHOD FOR FASTENING A FASTENER ELEMENT

(71) Applicant: PROFIL Verbindungstechnik GmbH & Co. KG, Friedrichsdorf (DE)

(72) Inventors: Georg Donhauser, Amberg (DE); Tobias Jene, Friedrichsdorf (DE); Amer Mahlme, Bad Homburg (DE)

(21) Appl. No.: 16/815,606

(22) Filed: Mar. 11, 2020

(30) Foreign Application Priority Data
Mar. 12, 2019 (DE) 102019106280.2

(51) Int. Cl. B21J 15/04; F16B 19/10; F16B 37/06

(52) U.S. Cl. CPC B21J 15/04; F16B 37/065; F16B 19/10

(57) ABSTRACT

The present invention relates to a method of fastening a fastening element to a workpiece, in particular to a sheet metal part, wherein the fastening element comprises a flange section provided for contact with the workpiece; and a fastening section which has a rivet section that at least sectionally bounds a hollow space in a peripheral direction and that is at least sectionally produced from a metal material, said method comprising the steps:
providing the workpiece;
inserting the fastening element into the workpiece; and at least sectionally reshaping the rivet section such that a reshaped section of the rivet element engages behind the workpiece at a side of the workpiece remote from the flange section,
   wherein the insertion and the reshaping are effected by a fastening movement of the fastening element in a common fastening direction; and
   wherein the fastening element, the workpiece, and/or a reshaping tool provided for reshaping the rivet section is/are acted on by a mechanical vibration, in particular by an ultrasound vibration, at least at times during the insertion of the fastening element into the workpiece and/or during the reshaping of the rivet section.

The invention relates to a method of fastening a fastening element to a workpiece, in particular to a sheet metal part.

In many areas of technology, in particular in automotive engineering, it is necessary to fasten an element to a workpiece. This element then, for example, serves to connect a further component to the workpiece. For example, the fastening element can be a nut element or a bolt element to which the component is screwed.

Known fastening elements of the above-mentioned kind frequently comprise a flange section provided for contact with the workpiece; and a fastening section which has a rivet section that at least sectionally bounds a hollow space in a peripheral direction and that is in particular at least sectionally produced from a metal material. The elements are frequently completely or largely composed of metal.

The fastening process is typically carried out as follows: First, the workpiece, for example a planar, panel-shaped component, is provided. Then, the fastening element is inserted into the workpiece and at least one section of the rivet section is reshaped (in particular by cold deformation) such that this section engages behind the workpiece at a side of the workpiece remote from the flange section. At least this section therefore passes through the workpiece.

The insertion and the reshaping are expediently effected by a fastening movement of the fastening element in a common fastening direction. This direction is, for example, defined by a straight line that is arranged coaxially to a longitudinal axis of the element.

However, considerable forces are required for this process, in particular to effect the reshaping of the rivet section. This has the result that a corresponding setting apparatus for setting the element at the workpiece has to have a very powerful and stable design. In addition, large forces that inter alia result in considerable wear likewise act on a reshaping tool that reshapes the rivet section.

It is therefore an object of the invention to improve the above-described method such that the components required for fastening the element are subjected to less load, but without compromises in this respect having to be made with regard to the reliability of the fastening of the element.

It has been recognized in accordance with the invention that this object is satisfied in a surprisingly simple manner if the fastening element is acted on by a mechanical vibration, in particular by an ultrasound vibration, at least at times during the insertion into the workpiece (e.g. a sheet metal part, a fiber-reinforced plastic component or the like) and/or during the reshaping of the rivet section. Significantly lower forces are then particularly required for the reshaping process than for conventional methods. It must be mentioned for reasons of completeness that the insertion and reshaping do not have to be strictly successive processes. It is by all means possible that the rivet section is already reshaped during the insertion of the element into the workpiece.

In general, it is also—additionally or alternatively—conceivable for the workpiece, and/or a reshaping tool provided for reshaping the rivet section to be acted on by a mechanical vibration, in particular by an ultrasound vibration, in order to optimize the fastening process.

Further embodiments of the method in accordance with the invention are set forth in the description, in the claims and in the enclosed drawings.

In accordance with an embodiment of the method, the fastening element, the workpiece, and/or a reshaping tool provided for reshaping the rivet section is/are acted on by a vibration that is oriented coaxially to the fastening movement. A vibration in the direction of the longitudinal axis of the element, which can also be its axis of symmetry, is designated as a longitudinal vibration.

It can be advantageous in various applications if an amplitude and/or a frequency of the vibration is/are varied during the insertion of the fastening element and/or during the reshaping of the rivet section. This also includes cases in which no action by vibration is provided (at times) on the insertion of the element or on the reshaping of the rivet section. The amplitude and/or the frequency of the vibration can also be kept substantially constant during the insertion of the fastening element and/or during the reshaping of the rivet section. In other words, said parameters and their variation in time (provided in this manner) can be adapted as required to the respective present situation.

The workpiece can be provided with an opening for receiving the rivet section (pre-punched workpiece). However, the method in accordance with the invention can be used in cases in which the provided workpiece at least does not have an opening in a region provided for the insertion of the fastening element. The element then produces an opening in the workpiece (self-piercing element) by its insertion.

The rivet section is preferably a continuous wall that surrounds the hollow space in the peripheral direction. For example, the wall is an annular wall that can be reshaped by a corresponding tool to produce an undercut that generates a fastening effect. It is generally preferred if the hollow space is open toward the workpiece in the direction of movement of the element. The hollow space can, for example, have a cylindrical basic shape.

The reshaping tool is in particular a die.

The present invention further relates to an apparatus for fastening a fastening element to a workpiece in accordance with a method in accordance with at least one of the preceding claims. The apparatus comprises a punch movable relative to the workpiece in a fastening direction for inserting the fastening element into the workpiece; and a die for at least sectionally reshaping a rivet section of the fastening element at least sectionally surrounding a hollow space such that a reshaped section of the rivet element engages behind the workpiece after the completion of the fastening. A first drive apparatus is provided by which a movement of the punch can be produced in the fastening direction, on which movement a mechanical vibration, in particular a vibration in the fastening direction, is superposed. In addition or as an alternative, a second drive apparatus can be provided by which the workpiece and/or a reshaping tool provided for reshaping the rivet section can be set into a vibration. The vibration produced by the second drive apparatus is preferably oriented coaxially to the fastening movement.

In accordance with an embodiment of the apparatus, the first drive apparatus and/or the second drive apparatus comprises/comprise an apparatus for producing an ultrasound vibration.

The reshaping tool can be a die which has a reshaping surface that cooperates with the rivet section, that is at least sectionally curved, and/or that is at least sectionally arranged obliquely with respect to the fastening direction and to a plane extending perpendicular thereto.

The present invention will be explained in the following purely by way of example with reference to an advantageous embodiment and to the enclosed drawings. There are shown:

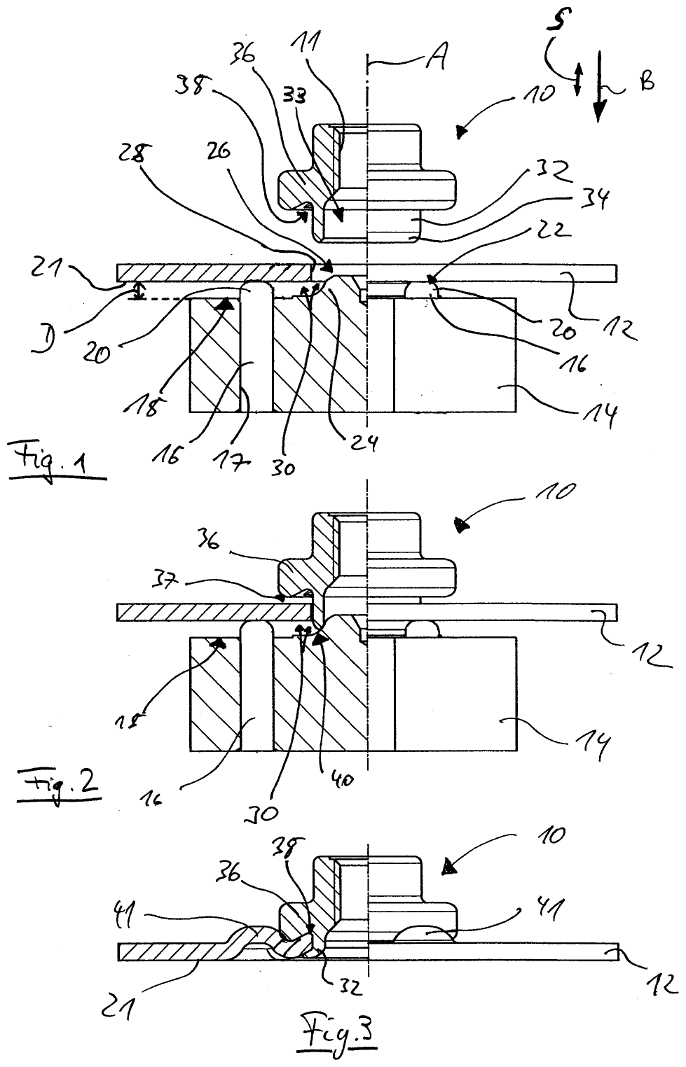

FIGS. 1 to 3 different stages of an embodiment of the method in accordance with the invention.

FIGS. 1 to 3 show three different states during a fastening of an internal thread 11 of a rotationally symmetrical rivet element 10 to a sheet metal part 12. It is understood that rivet elements of a different design can also be used instead of the rivet element 10 and that they do not necessarily have to be rotationally symmetrical. Rivet elements comprising a bolt section—with or without a thread—are also conceivable.

FIG. 1 shows a starting situation before the fastening process, wherein the rivet element 10 is arranged above the sheet metal part 12 in FIG. 1. A die 14 is present at the oppositely disposed side of the sheet metal part 12. The sheet metal part 12 is supported on spacers 16 that are fixedly connected to the die 14. This means that the spacers 16 do not move in the course of the fastening process. Dynamic spacers are likewise conceivable that e.g. have to escape downwardly when a threshold value of a force acting on them is exceeded.

FIGS. 1 to 3 are divided into two parts into a cross-sectional view at the left side and into a side view at the right side. The boundary between the two views extends through an axis of symmetry A that relates to the rotationally symmetrical rivet element 10, the sheet metal part 12—at least in a region around the fastening point—, and the die 14, as will be explained in more detail further below.

The spacers 16 extend in parallel with the axis A, wherein the spacers are screwed into corresponding bores 17 of the die 14 and are therefore releasably connected thereto. The spacers 16 are each made in the manner of pins and have an end section 20 that projects out of a contact surface 18 of the die 14. The length of the end sections 20 is set uniformly such that the sheet metal part 12 is horizontally supported on the spacers 16, i.e. perpendicular to the axis A. A spacing D is thereby set between a lower side 21 of the sheet metal part 12—i.e. the side of the sheet metal part 12 facing the contact surface 18—and the contact surface 18. Each end section 20 comprises a substantially convex support surface 22 facing the sheet metal part 12.

The spacing D can be adapted by an adjustment of the spacers 16 if necessary, e.g. if a different rivet element 10 should be used.

The die 14 has a conical die plunger 24 (here static, a die plunger escaping downwardly in a dynamic manner is also conceivable) that partly projects into a circular hole 26 provided at the sheet metal part 12. The axis A extends through the corresponding centers of the die plunger 24 and of the hole 26. In this respect, the axis A is thus an axis of symmetry for the sheet metal part 12—at least in the region around the hole 26—and for the die 14. The hole 26 was produced before the fastening process described here.

The sheet metal part 12 is planar in the region around the hole 26 and does not have a flare in this region. Optionally, however, the sheet metal part 12 can also be completely planar—as in the embodiment described here. However, this does not necessarily have to be the case.

A gap 30 is formed between a wall 28 of the hole 26 of the sheet metal part 12 and the lower side 21 of the sheet metal part 12, on the one hand, and the die plunger 24, on the other hand.

The rivet element 10 arranged above the sheet metal part 12 has a rivet section 32 that surrounds a cylindrical hollow space 33 in the peripheral direction and that is open toward the workpiece 12. The section 32 is an annular wall in the present example that extends away from a flange section 36 of the rivet element 10 in the axial direction. It has an end edge 34 that is rounded at the outside and conical at the inside. A functional section that supports the thread 11 at least in part is provided at the other side of the flange sections 36. The rivet element 10 is a nut element.

A peripheral groove 38 is provided in a transition region between the flange section 36 and the rivet section 32.

The outer diameter of the rivet section 32 is slightly smaller than the diameter of the hole 26 so that the rivet section 32 can be introduced into the hole 26.

Starting from the state shown in FIG. 1, the rivet element 10 is now moved in the axial direction in the direction toward the die 14 (direction of movement B), wherein the rivet section 32 is aligned with the hole 26 of the sheet metal part 12 (coaxial alignment).

FIG. 2 shows the arrangement of FIG. 1 in a second state in which the rivet section 32 is introduced into the hole 26. On a further movement of the rivet element 10 in the direction B toward the die 14, the inwardly disposed part of the end edge 34 of the rivet section 32 cooperates with a concave reshaping surface 40 of the die plunger 24 and the rivet section 32 is reshaped radially outwardly so that the rivet section 32 engages into the gap 30 and engages behind the sheet metal part 12. At least one part of the rivet section 32 has thus completely passed through the workpiece 12.

The rivet element 10 is displaced further in the direction toward the die 14 (direction of movement B) during the reshaping of the rivet section 32, wherein the flange section 36 comes into contact with a contact surface 37 at the sheet metal part 12. The length of the rivet section 32 or the spacing D is adapted such that the flange section 36 only comes into contact with the sheet metal part 12 when the rivet section 32 at least partly engages behind the sheet metal part 12 in the course of the reshaping, in particular when the reshaping that produces the engagement behind is completed.

The rivet element 10 is now moved further in the direction toward the die 14, wherein the sheet metal part 12 is moved along in the direction toward the contact surface 18 of the die 14. In this respect, the sheet metal part 12 is reshaped locally in the region of the spacers 16 so that the end sections 20 of the spacers 16 engage into the sheet metal part 12 and the sheet metal part 12 comes into contact with the contact surface 18. In this connection, the end sections 20 of the spacers 16 that reshape the sheet metal part 12 cause a respective elevated portion 41 of the sheet metal part 12 at the side remote from the die 14, as will be explained in more detail further below.

In FIG. 3, the sheet metal part 12 is shown with the rivet element 10 after the completion of the fastening process. It can be seen that the sheet metal part 12 is reshaped in the region of the rivet section 32 which engages behind the sheet metal part 12 during its movement B from the position shown in FIG. 2 in the direction toward the die 14. In this respect, the region of the sheet metal part 12 originally adjacent to the hole 26 deflects due to a cooperation with the rivet section 32 that engages behind the sheet metal part 12 and that is pressed into the groove 38 of the rivet element 10. At the same time, the engaging-behind rivet section 32 is completely displaced into the plane of the sheet metal part 12 that extends perpendicular to the axis A by a cooperation with the reshaping surface 40 of the die plunger 24 so that the lower side 21 of the sheet metal part 12 facing the die 14 is substantially planar. This means that the reshaped rivet section 32 does not project out of the plane of the lower side 21. In addition, the rivet section 32 is deformed in part such that the rivet section 32 nestles against the sheet metal part 12. A particularly good shape matching and force transmission between the rivet element 10 and the sheet metal part 12 are hereby achieved.

As mentioned above, the end sections 20 of the spacers 16 engage into the sheet metal part 12 in the course of the movement of the sheet metal part 12 toward the contact surface 18 of the die 14. As a result, the already mentioned elevated portions 41 are thereby produced at the upper side of the sheet metal part 12 (FIG. 3).

The above statements serve as a purely exemplary explanation of a fastening process of a fastening element. It is understood that such an element—when using a suitable die—can also be fastened to a workpiece that is not prepared or that is not pre-punched. The element is then self-piercing.

The design of the die 14 provided for reshaping the rivet section 32 can also differ from that shown. It is therefore conceivable that no spacers 16 are present, but that the sheet metal part 12 rather lies directly on the contact surface 18. The die then preferably has a (possibly annular) recess which receives the end of the rivet section 32 that penetrated the part 12 and/or contributes to its reshaping.

In accordance with the invention, the rivet element 10 is acted on by a vibration on the insertion into the sheet metal part 12 in order to minimize the force required for the insertion. The vibration is superposed on the movement B and oriented coaxially thereto, as indicated by the double arrow S in FIG. 1. The vibration S is consequently a longitudinal vibration. In general, it is also—additionally or alternatively—possible to provide a transverse vibration component, i.e. a vibration in a plane that is arranged perpendicular to the direction of movement B.

Superpositions with vibrations in the ultrasound range have proven to be particularly efficient.

The vibration S is preferably also maintained at least at times during the reshaping of the rivet section 32 since this process is associated with a substantial exertion of force that can exceed (frequently even by a multiple) the exertion of force required for the insertion of the element 10 into the sheet metal part 12. In many cases, this even applies to self-piercing elements.

The exertion of force required for the fastening of the element 10 is reduced by the vibration-superposed movement B, S of the element 10, which enables a simpler design of a corresponding setting apparatus. In addition, the wear of the die 14 is reduced.

However, it is not absolutely necessary to provide a movement B, S acted on by vibration during the insertion of the element 10 into the sheet metal part 12. It very generally applies that the vibration S can be superposed on the movement B as required. It can vary over time, be it with respect to its amplitude and/or its frequency. This also applies to transverse vibration components—if provided.

### Reference Numeral List

10 rivet element

11 internal thread

12 sheet metal part

14 die

16 spacer

17 bore

18 contact surface

20 end section

21 lower side of the sheet metal part

22 support surface

24 die plunger

26 hole

28 wall

30 gap

32 rivet section

33 hollow space

34 end edge

36 flange section

37 contact surface

38 groove

40 reshaping surface

41 41 elevated portion

A axis of symmetry

B direction of movement

S vibration

1. A method of fastening a fastening element to a workpiece, the fastening element comprising a flange section provided for contact with the workpiece; and the fastening element further comprising a fastening section which has a rivet section that at least sectionally bounds a hollow space in a peripheral direction, said method comprising the steps of:
providing the workpiece;
inserting the fastening element into the workpiece; and at least sectionally reshaping the rivet section such that a reshaped section of the rivet element engages behind the workpiece at a side of the workpiece remote from the flange section,
wherein the insertion and the reshaping are effected by a fastening movement of the fastening element in a common fastening direction; and
wherein at least one of the fastening element, the workpiece, and a reshaping tool provided for reshaping the rivet section is acted on by a mechanical vibration, at least at times during at least one of the insertion of the fastening element into the workpiece and the reshaping of the rivet section.

2. The method in accordance with claim 1, wherein said workpiece is a sheet metal part.

3. The method in accordance with claim 1, wherein the rivet section is at least sectionally produced from a metal material.

4. The method in accordance with claim 1, wherein the mechanical vibration is an ultrasound vibration.

5. The method in accordance with claim 1, wherein at least one of the fastening element, the workpiece, and a reshaping tool provided for reshaping the rivet section is acted on by a vibration that is oriented coaxially to the fastening movement.

6. The method in accordance with claim 1, wherein at least one of an amplitude and a frequency of the vibration is varied during at least one of the insertion of the fastening element and the reshaping of the rivet section.

7. The method in accordance with claim 1, wherein at least one of an amplitude and a frequency of the vibration is kept substantially constant during at least one of the insertion of the fastening element and the reshaping of the rivet section.

8. The method in accordance with claim 1, wherein the workpiece is provided with an opening for receiving the rivet section.

9. The method in accordance with claim 1, wherein the workpiece provided at least does not have an opening in a region provided for the insertion of the fastening element.

10. The method in accordance with claim 1, wherein the rivet section is a continuous wall that surrounds the hollow space in the peripheral direction.

11. The method in accordance with claim 1, wherein the reshaping tool is a die.

12. An apparatus for fastening a fastening element to a workpiece, the fastening element comprising a flange section provided for contact with the workpiece; and the fastening element further comprising a fastening section which has a rivet section that at least sectionally bounds a hollow space in a peripheral direction, the apparatus having a punch movable relative to the workpiece in a fastening direction for inserting the fastening element into the workpiece, and having a die for at least sectionally reshaping a rivet section of the fastening element at least sectionally surrounding a hollow space such that a reshaped section of the rivet element engages behind the workpiece after the completion of the fastening, wherein a first drive apparatus is provided by which a movement of the punch can be produced in the fastening direction, on which movement a mechanical vibration is superposed; and/or wherein a second drive apparatus is provided by which at least one of the workpiece and a reshaping tool provided for reshaping the rivet section can be set into a vibration.

13. The apparatus in accordance with claim 12,
wherein the mechanical vibration is a vibration in the fastening direction,

14. The apparatus in accordance with claim 12,
wherein at least one of the first drive apparatus and the second drive apparatus comprises an apparatus for producing an ultrasound vibration.

15. The apparatus in accordance with claim 12,
wherein the reshaping tool is a die which has a reshaping surface that cooperates with the rivet section.

16. The apparatus in accordance with claim 12,
wherein the reshaping tool is a die which has a reshaping surface that is at least sectionally curved.

17. The apparatus in accordance with claim 12,
wherein the reshaping tool is a die which has a reshaping surface that cooperates with the rivet section and that is at least sectionally arranged obliquely with respect to the fastening direction and to a plane extending perpendicular thereto.
